(19) United States
(12) Patent Application Publication
(10) Pub. No.: US 2003/0026731 A1
(43) Pub. Date: Feb. 6, 2003

(54) Self defense test strip package

(76) Inventor: Cordani Peter, Palm Beach Gardens, FL (US)

Correspondence Address: MCHALE & SLAVIN, 4440 PGA BLVD, SUITE 402, PALM BEACH GARDENS, FL, 33410

(21) Appl. No.: 09/923,507

(22) Filed: Aug. 6, 2001

(51) Int. Cl. G01N 31/22

(52) U.S. Cl. 422/58; 422/56; 422/59; 422/60; 422/70; 436/901

(57) ABSTRACT

A package for holding and disguising a chromatographic test of food and drink is formed in the shape of a drinking straw or stirrer. The package encloses test strips which are sensitive to particular drugs and produce a color change upon contact with the drug. The package has a view port or slit to observe the condition of the test strip upon contact with food and drink.

### FIELD OF THE INVENTION

This invention relates to a package containing materials for surreptitious in situ chemical testing of food and drink, prior to ingestion, with an immediate read out of the results of the test.

1. Background of the Invention

The incidence of unintentional ingestion of certain drugs has increased with the availability of legal and illicit drugs. For example, numerous, “date rape” cases have involved providing the victim with a particular drug, such as “Rohypnol” or flunitrazepam, through social activities, such as eating or drinking. Of longer standing, is the use of a Mickey Finn, chloral hydrate, to render an unsuspecting person unconscious.

It is not unheard of to secretly give certain drugs to those persons, who do not wish to participate or do not consent to partake in voluntary ingestion of legal or illegal drugs, either as a joke or with more malevolent intent. Usually, such secret application is through normally ingested materials. For example, the marijuana laced brownie is a fairly notorious story.

2. Description of the Prior Art

There are various small test strips in the prior art that are used by laboratory personnel or others to test for the presence of such compounds as amphetamines, barbituates, benzodiazepines, cocaine, opiates, methadone, marijuana, methamphetamines, phencyclidine, and tricyclic antidepressants. However, these strips are usually used for testing urine samples to detect drug abuse rather than as a preventive measure. One such device is manufactured by American Bio Medica Corporation as “Rapid Drug Screen” ™.

Another assay device is found in U.S. Pat. No. 6,248,598 B1 issued Jun. 19, 2001 to Bogema. This test strip also tests for the presence of drugs, in the body, through a sample of saliva.

These devices have certain reagents incorporated into absorbent test strips. These dry test strips contain the reagent(s) in the solid phase providing convenient packaging, handling and testing. A particular reagent will have a chemical reaction in the presence of a particular drug to activate a particular color which is visually evident, as disclosed by Bogema, above. The absorbent strips are protected by a housing to prevent damage or accidental activation. The test strip is either extended outside the housing or an aperture in the housing is exposed to permit the test liquid to contact the test strip.

When the test strips are introduced into urine or saliva, the bodily fluid is absorbed and, through capillary action, comes into contact with the solid reagent chromatographically sensitive to a particular drug. There may be another compound included with the reagent which is activated by the positive reaction of the reagent to produce a certain color change in the test strip. The presence of a certain color after the exposure is an indication of a “positive” test for the drug. The determination is accomplished in a matter of minutes.

The chemistry involved in these prior art test strips is well known, as shown by the above references. The visual results of such testing may include the presence of a particular color for a negative result and another color for a positive result. Also, the negative test result may involve no color change.

These devices and other similar tests determine the presence or absence of certain drugs in the body by sampling the body fluids. These tests are reactive in that the drugs have already been ingested. In contrast, the testing taught by this invention is pro-active to prevent ingestion of certain drugs.

### SUMMARY OF THE INVENTION

What is needed to protect the innocent and prevent inadvertent dosing is a small, simple, un-obtrusive, portable device that can be brought into contact with food and drink to determine whether the food or drink is contaminated with certain drugs. Such a device would quickly provide the user with an indication of the presence or absence of certain drugs.

The devices of this invention are packaged in an unobtrusive shape similar to a drinking straw or stirrer. The user may carry one or more of the packages in a purse or clothing pocket. Such a disguised device could be inserted into a suspicious offering without drawing undue attention. The package also serves as the holder and support for the test strip during use of the device.

The devices may have a series of discrete testing reagents or areas to test more than one offering for a particular drug or to test for different drugs in one offering.

Accordingly, it is an objective of the instant invention to provide an unobtrusive drug testing apparatus for chromatographically determining the presence or absence of a particular drug in the food or drink about to be ingested.

It is a further objective of the instant invention to provide a drug testing apparatus with an appearance similar to normal utensils used to with food or beverages.

It is yet another objective of the instant invention to teach an elongated testing apparatus having several discrete drug testing areas along its length. The drug testing areas each have a viewing port for visually confirming the results of each test.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 shows a perspective of the testing strip of this invention with an end wall partially broken away;

FIG. 2 shows a perspective of the test strip;

FIG. 3 shows a perspective of the end wall and mounted test strips;

FIG. 4 shows a test strip during testing of a drink; and

FIG. 5 is a perspective of a modification of the test strip; and

FIG. 6 is an exploded perspective of the handle portion of FIG. 4 showing the absorbent wipe.

### DETAILED DESCRIPTION OF THE INVENTION

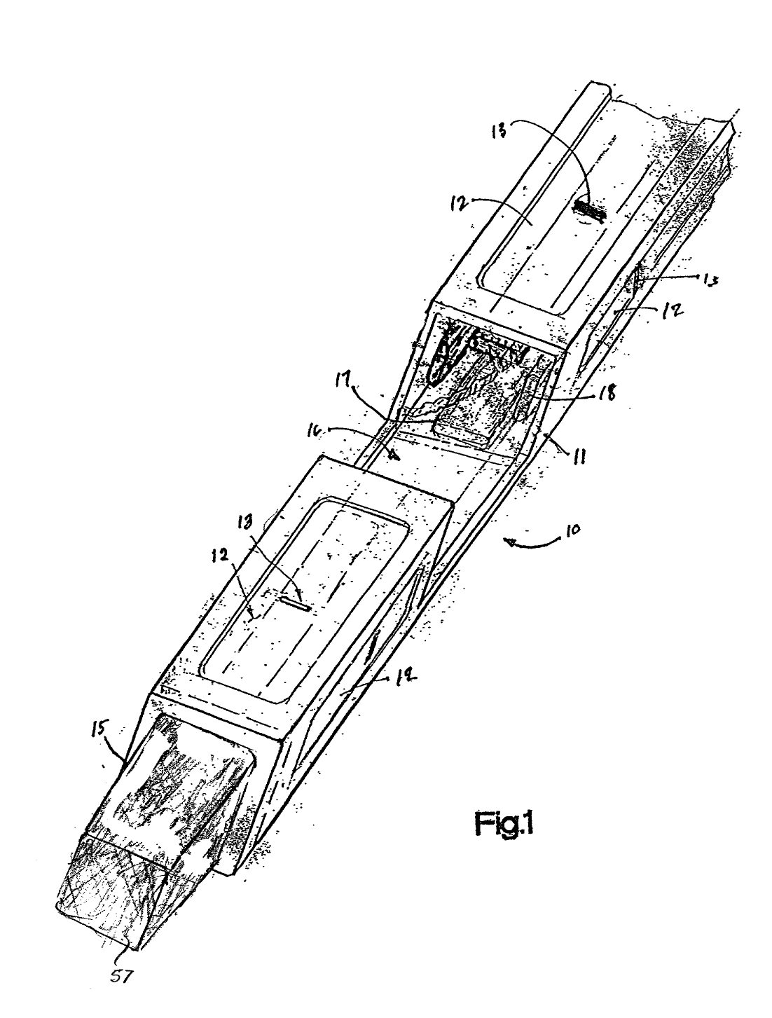

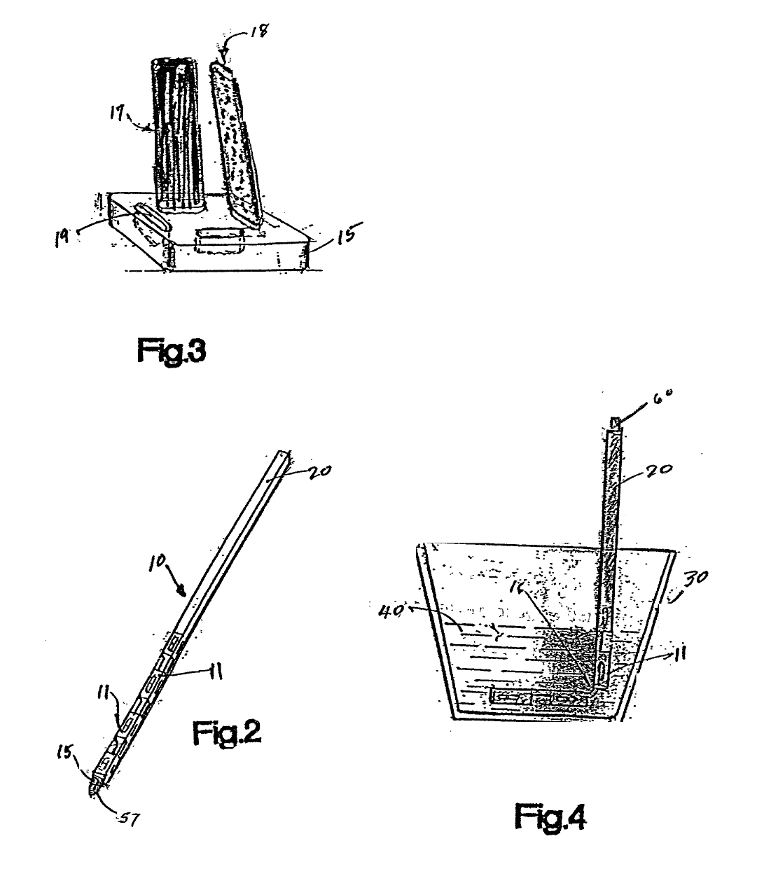

The disguised package 10, shown in FIGS. 1 and 2, is approximately the size of a conventional drinking straw or a drink stirrer. It is made of a plastic casing having several solid state test modules 11 and a handle portion 20. The test package is normally sterilely wrapped individually to avoid contamination during shipping and storage. Several of the packages may be wrapped together to serially test several samples for the same drug. Alternatively, several of the packages may be wrapped together to test for several different drugs. The user of the self-defense device would merely bring the uncontaminated test package into contact with the liquid to be tested, for example, by placing the test assembly in a container 30 holding a suspicious drink 40, as shown in FIG. 4. Within moments, an indication of the results of the test are visually presented to the user.

In FIG. 1, the package 10 is shown with a rectilinear shape however, the shape may be cylindrical or multi-faceted. Each wall of the test module 11 has a window 12. The windows 12 may be transparent, opaque or solid. The visual results of the test are registered at the indicator 13. In the opaque and solid windows the indicator is an aperture 13 but in a transparent window the indicator 13 may be a line showing the location of the reagent and the visual result.

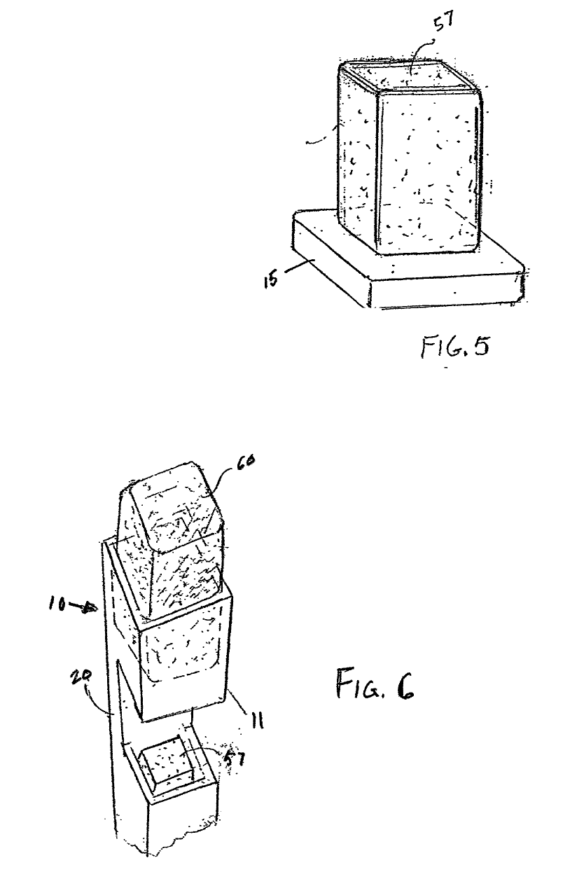

The bottom or distal end of the module is a solid base 15. As shown in FIG. 3, the base 15 supports side walls containing the windows 12 and the solid reagent patches 17 and 18. As shown, there is a reagent patch for each side of the square wall. However, the module may have an open side. Also shown, in FIGS. 1 and 5, the reagent for a single test may be contained in a single block patch 57. The multiple test strips are interchangeable with the single test strip and vice versa.

In practice, each reagent patch may include the same reactive chemical compound(s) to test for the same drug or a different reactive chemical compound(s) in each patch to test for different drugs, simultaneously.

The test strips 17, 18, and 57 are of conventional construction with the particular reagent(s) necessary for testing for a particular drug impregnated on a capillary substrate, such as described above by Bogema, including reagents sensitive to diazepam. The strips 17, 18, and 57 may be adhesively mounted in pre-formed recesses 19 in the end wall 15 or they may be molded into the end wall. The strips are oriented along the longitudinal axis of the assembly and do not contact each other. Each of the strips extend from the base 15 upwardly beyond the indicator 13.

In another embodiment, not shown, the base 15 is not present. The test strips 17, 18, and 57 are adhered or otherwise fixed to the side walls or windows 12. The material to be tested merely flows through the enclosure formed by the side walls and windows 12.

At least that portion of the test strips 17 and 18 that are positioned for viewing at the indicator 13 have the particular impregnated reagent(s) necessary for a particular test. The substrate of the test strips may be made of absorbent material or nonabsorbent material which will become saturated with the test sample through capillary action once a portion of the strip is in contact with the sample. As shown in FIGS. 1 and 2, one of the single test strips 57 may extend outwardly from the end of the module 11 to be viewed directly.

The top or proximal end, opposite the base 15, of each test module is open and provides access to the liquid sample. Upon introduction of the liquid sample, the test strip is wetted by capillary action. Within a short period of time, a visual indication of the presence or absence of a particular drug will appear at the indicator 13.

By using the disguised package 10, the user has employed self-defense measures to protect herself from potential harm. If the test is negative, the user may consume the tested material, as desired and appropriate. If the test is positive, the user is alerted by the visual indication and may proceed to dispose of the material in any desired manner.

The package 10 is formed to allow as many test modules as desired to come in contact with a minimum sample of the food or drink to be tested. Each test module is completely separated from the others so that more than one module is not activated inadvertently. The modules 11 are connected together by a living hinge 16 which is an integral nonabsorbent plastic element of the package 10. As shown in FIG. 4, the hinge 16 permits the package to bend to bring more than one module into contact with a short sample. The hinge 16 may or may not be resilient depending on the plastic compound forming the package. It is only necessary for the hinge to be capable of repeated bending without breaking.

The handle portion 20 of the disguised package 10 may have an absorbent element 60 mounted on the free end. The absorbent wipe 60 may act as a swab to capture and/or remove small samples, as desired. As shown in FIG. 6, the absorbent element 60 is fixed in the shaft of the handle portion similar to the construction of a test module. The element 60 is physically removed from the test strips 17, 18 or 57 to prevent contamination of the sample with the reagent.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

What is claimed is:

1. A self-defense package for indicating the presence of a particular drug in food and drink before ingestion, said package comprising an elongated body having a distal end and a proximal end, a test module near said distal end, said test module having a capillary substrate, said capillary substrate including a particular reagent chromatographically sensitive to a particular drug, whereby said package is manipulated to bring said test module in contact with food and drink and said package presents a visual chromatic indicator as to the presence of said particular drug in the food and drink.

2. A package of claim 1 wherein said test module forms an enclosure having a base connected to said elongated body and an open top, said base supporting side walls and said capillary substrate within said enclosure, said side walls having means for visually inspecting a portion of said capillary substrate.

3. A package of claim 2 wherein said enclosure includes a plurality of capillary substrates and said side walls have means for visually inspecting said plurality of substrates.

4. A package of claim 3 wherein each of said plurality of capillary substrates is chromatographically sensitive to a different particular drug.

5. A package of claim 2 wherein a plurality of said test modules are disposed along the length of said elongated body, said elongated body extending between said enclosures.

6. A package of claim 5 wherein said capillary substrate in each of said plurality of test modules is chromatographically sensitive to a different drug.

7. A package of claim 5 wherein said enclosures include a plurality of capillary substrates and said enclosures have means for visually inspecting said plurality of capillary substrates.

8. A package of claim 7 wherein said plurality of capillary substrates include a different reagent chromatographically sensitive to a different drug.

9. A package of claim 5 wherein said elongated body extending between said enclosures is flexible whereby said elongated body can bend between said test modules.

10. A self defense package for disguising and performing a chromatographic test on food and drink before ingestion, said package comprising an elongated body having a distal end and a hand held proximal end, said distal end having a plurality of test modules adapted to be placed in food and drink, said plurality of test modules being disposed along the length of said distal end of said elongated body, said elongated body extending between each of said plurality of test modules, each of said test modules formed with walls extending approximately parallel to said elongated body, said test modules each having test strips chromatographically sensitive to a particular drug, and said walls including windows for viewing said test strips whereby food and drink can be surreptitiously visually tested for the presence of a particular drug by placing said test modules in contact with food and drink.

11. A package of claim 10 wherein said plurality of test modules each have a plurality of test strips chromatographically sensitive to a different drug.

12. A package of claim 11 wherein said plurality of test modules each have a plurality of test strips each chromatographically sensitive to a different drug.

13. A package of claim 10 wherein each of said test modules have a base extending approximately normal to said elongated body and supporting said walls and said test strips.
